(19) United States
(12) Patent Application Publication
(10) Pub. No.: US 2025/0262783 A1
(43) Pub. Date: Aug. 21, 2025

(54) SHEET CUTTING DEVICE AND IMAGE FORMING APPARATUS

(71) Applicant: FUJIFILM Business Innovation Corp., Tokyo (JP)

(72) Inventors: Naoto HAMABATA, Kanagawa (JP); Soma HASHIMOTO, Kanagawa (JP); Masashi IKEDA, Kanagawa (JP)

(73) Assignee: FUJIFILM Business Innovation Corp., Tokyo (JP)

(21) Appl. No.: 18/773,238

(22) Filed: Jul. 15, 2024

(30) Foreign Application Priority Data
Feb. 16, 2024 (JP) 2024-021655

(51) Int. Cl. B26D 1/24; B26D 1/157; B26D 7/26

(52) U.S. Cl. CPC B26D 1/245; B26D 1/1575; B26D 7/2635

(57) ABSTRACT

A sheet cutting device including first and second rotating blades that mesh with each other at inner and outer positions in an axial direction and that cut a sheet, and a restoring unit. When a positional relationship between the inner and outer positions of the first and second rotating blades in the axial direction is reversed, the restoring unit releases the first and second rotating blades from each other and moves at least one of the first and second rotating blades in the axial direction to restore the positional relationship between the inner and outer positions to an original state.

### CROSS-REFERENCE TO RELATED APPLICATIONS

This application is based on and claims priority under 35 USC 119 from Japanese Patent Application No. 2024-021655 filed Feb. 16, 2024.

### BACKGROUND

### (i) Technical Field

The present disclosure relates to a sheet cutting device and an image forming apparatus.

### (ii) Related Art

Japanese Unexamined Patent Application Publication No. 2005-262408, for example, describes a technology related to a sheet cutting device according to the related art.

According to Japanese Unexamined Patent Application Publication No. 2005-262408, a first round blade and a second round blade overlap and rotate in mesh with each other. A sheet is placed between the first round blade and the second round blade and moved relative to the first round blade and the second round blade so that the sheet is cut in the moving direction.

### SUMMARY

Aspects of non-limiting embodiments of the present disclosure relate to a technology for enabling first and second rotating blades that have been unmeshed to return to the original state without the need for manual intervention by, for example, a customer engineer.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a sheet cutting device including first and second rotating blades that mesh with each other at inner and outer positions in an axial direction and that cut a sheet, and a restoring unit. When a positional relationship between the inner and outer positions of the first and second rotating blades in the axial direction is reversed, the restoring unit releases the first and second rotating blades from each other and moves at least one of the first and second rotating blades in the axial direction to restore the positional relationship between the inner and outer positions to an original state.

### BRIEF DESCRIPTION OF THE DRAWINGS

Exemplary embodiments of the present disclosure will be described in detail based on the following figures, wherein:

FIG. 1 illustrates the overall structure of an image forming apparatus including a sheet cutting device according to a first exemplary embodiment of the present disclosure;

FIG. 2 illustrates the structure of a post-processing device of the image forming apparatus according to the first exemplary embodiment of the present disclosure;

FIG. 3 is a plan view illustrating the structure of the sheet cutting device according to the first exemplary embodiment of the present disclosure;

FIGS. 4A and 4B are side views illustrating the structure of relevant parts of the sheet cutting device according to the first exemplary embodiment of the present disclosure;

FIGS. 5A and 5B are a side view and a front view illustrating the structure of a relevant part of the sheet cutting device according to the first exemplary embodiment of the present disclosure;

FIG. 6 is an enlarged view illustrating the structure of a relevant part of the sheet cutting device according to the first exemplary embodiment of the present disclosure;

FIG. 7 illustrates the structure of a relevant part of the sheet cutting device according to the first exemplary embodiment of the present disclosure;

FIGS. 8A, 8B, and 8C illustrate the operation of the sheet cutting device;

FIG. 9 is a perspective view illustrating the structure of a retracting mechanism;

FIGS. 10A and 10B are side views illustrating the structure of the retracting mechanism;

FIG. 11 illustrates the operation of the sheet cutting device according to the first exemplary embodiment of the present disclosure;

FIG. 12 illustrates the operation the sheet cutting device;

FIGS. 13A, 13B, and 13C illustrate the operation of the sheet cutting device according to the first exemplary embodiment of the present disclosure;

FIGS. 14D and 14E illustrate the operation of the sheet cutting device according to the first exemplary embodiment of the present disclosure;

FIG. 15 illustrates the structure of a sheet cutting device according to a second exemplary embodiment of the present disclosure;

FIG. 16 illustrates the structure of a sheet cutting device according to a third exemplary embodiment of the present disclosure;

FIG. 17 illustrates the structure of a relevant part of the sheet cutting device according to the third exemplary embodiment of the present disclosure;

FIG. 18 illustrates the structure of a sheet cutting device according to a fourth exemplary embodiment of the present disclosure;

FIGS. 19A, 19B, and 19C illustrate a known operation of the sheet cutting device;

FIGS. 20A and 20B illustrate the structure of a modification of the sheet cutting device according to the fourth exemplary embodiment of the present disclosure; and

FIGS. 21A, 21B, and 21C illustrate the structure of another modification of the sheet cutting device according to the fourth exemplary embodiment of the present disclosure.

### DETAILED DESCRIPTION

Exemplary embodiments for carrying out the present disclosure (hereinafter referred to as “exemplary embodiment”) will now be described with reference to the drawings.

### First Exemplary Embodiment

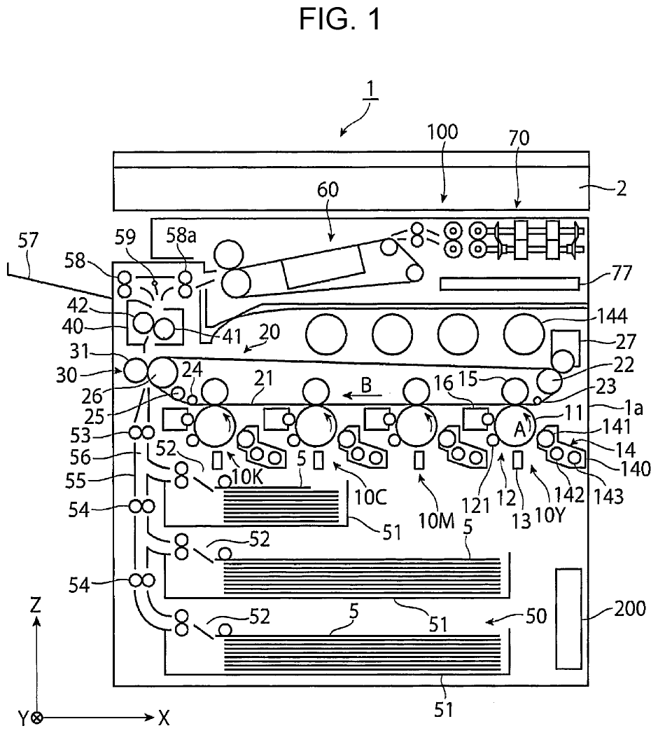

FIG. 1 illustrates an image forming apparatus 1 including a sheet cutting device according to a first exemplary embodiment. In FIG. 1, X denotes a horizontal direction (width direction) of the image forming apparatus, Y denotes a depth direction of the image forming apparatus, and Z denotes a vertical direction of the image forming apparatus.

### Overall Structure of Image Forming Apparatus

The image forming apparatus 1 according to the first exemplary embodiment is formed as, for example, a color printer. This image forming apparatus 1 includes an apparatus body 1a and an image reading device 2 for reading an image of a document (not illustrated) disposed above the apparatus body 1a. The image forming apparatus 1 has a function of copying the image of the document read by the image reading device 2, and also functions as, for example, a color printer for recording image information transmitted from a host computer (not illustrated) or the like or image information stored in a memory, such as ROM, that is removably attachable to the apparatus body 1a.

The image forming apparatus 1 includes plural image forming devices 10, an intermediate transfer device 20, a sheet feeding device 50, and a fixing device 40 disposed in the apparatus body 1a. Each image forming device 10 forms a toner image by using toner contained in developer. The intermediate transfer device 20 carries the toner images formed by the image forming devices 10 and transports the toner images to a second transfer position. At the second transfer position, the toner images are transferred onto a recording paper sheet 5, which is an example of a sheet, in a second transfer process. The sheet feeding device 50 stores recording paper sheets 5 to be supplied to the second transfer position of the intermediate transfer device 20, and supplies each recording paper sheet 5. The fixing device 40 fixes the toner images that have been transferred onto the recording paper sheet 5 by the intermediate transfer device 20 in the second transfer process. The image forming devices 10 and the intermediate transfer device 20 constitute an image forming unit that forms an image on the recording paper sheet 5. The apparatus body 1a of the image forming apparatus 1 is formed of, for example, support structural members and an outer covering.

The image forming devices 10 include four image forming devices 10Y, 10M, 10C, and 10K for exclusively forming toner images of four colors, which are yellow (Y), magenta (M), cyan (C), and black (K), respectively. The four image forming devices 10 (Y, M, C, and K) are arranged along one line in an inner space of the apparatus body 1a.

As illustrated in FIG. 1, each of the yellow (Y), magenta (M), cyan (C), and black (K) image forming devices 10 (Y, M, C, and K) includes a rotating photoconductor drum 11 as an example of an image carrier that carries an electrostatic latent image. Devices described below are arranged around the photoconductor drum 11 as examples of toner-image-forming units. These devices include a charging device 12, an exposure device 13, a developing device 14, a first transfer device 15, and a drum cleaning device 16. The charging device 12 charges a peripheral surface (image carrying surface) of the photoconductor drum 11 on which an image can be formed to a predetermined potential. The exposure device 13 forms an electrostatic latent image (for the corresponding color) having a potential difference by irradiating the charged peripheral surface of the photoconductor drum 11 with light based on image information (signal). The developing device 14 develops the electrostatic latent image into a toner image by using the toner contained in the developer of the corresponding color (Y, M, C, or K). The first transfer device 15 performs a first transfer process in which the toner image is transferred to the intermediate transfer device 20. The drum cleaning device 16 cleans the image carrying surface of the photoconductor drum 11 by removing residual toner and other deposits from the image carrying surface after the first transfer process.

The photoconductor drum 11 is obtained by forming the image carrying surface having a photoconductive layer made of a photosensitive material (photosensitive layer) on a peripheral surface of a hollow or solid cylindrical base material that is grounded. This photoconductor drum 11 is supported so as to be rotatable in the direction of arrow A when power is transmitted thereto from a driving device (not shown).

The charging device 12 includes a contact charging roller 121 arranged in contact with the photoconductor drum 11. A cleaning roller (not illustrated) for cleaning the surface of the charging roller 121 is disposed behind the charging roller 121. A charging voltage is applied to the charging roller 121 of the charging device 12. In the case where the developing device 14 performs a reversal development, a voltage having the same polarity as the polarity to which the toner supplied from the developing device 14 is charged is supplied as the charging voltage.

The exposure device 13 irradiates the charged peripheral surface of the photoconductor drum 11 with light corresponding to image information to form the electrostatic latent image. The image information may be, for example, image information of a document read by the image reading device 2, image information input to the image forming apparatus 1 from an external unit, or image information stored in a memory, such as ROM, that is removably attachable to the apparatus body 1a. When a latent image is to be formed, the exposure device 13 receives the image information (signal) of the document read by the image reading device 2 or the image information (signal) input to the image forming apparatus 1 by any method.

The exposure device 13 is composed of an LED print head that forms an electrostatic latent image by irradiating the photoconductor drum 11 with light corresponding to the image information. The LED print head includes plural light emitting diodes (LEDs) serving as light emitting elements arranged in the axial direction of the photoconductor drum 11. The exposure device 13 may be configured to perform deflection scanning in which the photoconductor drum 11 is scanned with laser light corresponding to the image information in the axial direction.

The developing device 14 includes a developing roller 141, a stirring supply member 142, a stirring transport member 143, and a layer-thickness regulating member (not illustrated), which are disposed in a housing 140 having an opening facing the photoconductor drum 11 and a storage chamber for the developer. The developing roller 141 carries the developer and transports the developer to a developing region in which the developing roller 141 faces the photoconductor drum 11. The stirring supply member 142 is, for example, a screw auger that supplies the developer while stirring the developer so that the developer passes the developing roller 141. The stirring transport member 143 is, for example, a screw auger that transports the developer to the stirring supply member 142 while stirring the developer. The layer-thickness regulating member regulates the amount (layer thickness) of the developer carried by the developing roller 141. A developing voltage is applied between the developing roller 141 of the developing device 14 and the photoconductor drum 11 by a power supply device (not shown). Each of the developers of the four colors is, for example, a two-component developer containing non-magnetic toner and magnetic carrier.

The first transfer device 15 is a contact transfer device including a first transfer roller that rotates while being in contact with the periphery of the photoconductor drum 11 with the intermediate transfer belt 21 interposed therebetween and to which a first transfer voltage is supplied. The first transfer voltage is a direct-current voltage having a polarity opposite to the polarity to which the toner is charged, and is supplied by the power supply device (not shown).

The drum cleaning device 16 includes a cleaning plate (not illustrated) and a transport member. The cleaning plate is pressed against the peripheral surface of the photoconductor drum 11 at a predetermined pressure after the first transfer process, and cleans the peripheral surface by removing residual toner and other deposits therefrom. The transport member is, for example, a screw auger that collects the deposits, such as toner, removed by the cleaning plate and transports the collected deposits toward a collection system (not shown).

As illustrated in FIG. 1, the intermediate transfer device 20 is disposed above the image forming devices 10 (Y, M, C, and K) in the vertical direction Z. The intermediate transfer device 20 includes the intermediate transfer belt 21, plural belt support rollers 22 to 26, a second transfer device 30, and a belt cleaning device 27. The intermediate transfer belt 21 rotates in the direction shown by arrow B while passing through first transfer positions, which are positions between the photoconductor drums 11 and the corresponding first transfer devices 15 (first transfer rollers). The belt support rollers 22 to 26 retain the intermediate transfer belt 21 in a desired state and support the intermediate transfer belt 21 in a rotatable manner at the inner surface of the intermediate transfer belt 21. The second transfer device 30 is disposed so as to oppose the outer peripheral surface (image carrying surface) of a portion of the intermediate transfer belt 21 supported by the belt support roller 26, and performs a second transfer process in which the toner images on the intermediate transfer belt 21 are transferred onto the recording paper sheet 5. The belt cleaning device 27 cleans the outer peripheral surface of the intermediate transfer belt 21 by removing residual toner, paper dust, and other deposits from the outer peripheral surface of the intermediate transfer belt 21 after the intermediate transfer belt 21 has passed the second transfer device 30.

The intermediate transfer belt 21 may be, for example, an endless belt made of a material obtained by dispersing a resistance adjuster, such as carbon black, into a synthetic resin, such as a polyimide resin or a polyamide resin. The belt support roller 22 serves as a driving roller that is rotationally driven by a driving device (not shown). The belt support rollers 23 and 24 serve as surface positioning rollers that retain the position of the intermediate transfer belt 21. The belt support roller 25 serves as a tension-applying roller that applies tension to the intermediate transfer belt 21. The belt support roller 26 serves as a backup roller for the second transfer process.

Referring to FIG. 1, the second transfer device 30 is a contact transfer device including a second transfer roller 31 to which a second transfer voltage is applied and that rotates while being in contact with the peripheral surface of the intermediate transfer belt 21 at a second transfer position. The second transfer position is the position of the outer peripheral surface of the portion of the intermediate transfer belt 21 that is supported by the belt support roller 26 of the intermediate transfer device 20. The second transfer voltage is a direct-current voltage having a polarity that is the same as or opposite to the polarity to which the toner is charged, and is supplied to the second transfer roller 31 or the belt support roller 26 of the intermediate transfer device 20.

The belt cleaning device 27 includes a cleaning plate (not illustrated) and a transport member. The cleaning plate is pressed against the peripheral surface of the intermediate transfer belt 21 at a predetermined pressure after the second transfer process, and cleans the peripheral surface by removing residual toner and other deposits therefrom. The transport member is, for example, a screw auger that collects the deposits, such as toner, removed by the cleaning plate and transports the collected deposits toward a collection system (not shown).

The fixing device 40 includes a roller-shaped or belt-shaped heating rotating body 41 and a roller-shaped or belt-shaped pressing rotating body 42. The heating rotating body 41 is heated by a heating unit so that the surface temperature thereof is maintained at a predetermined temperature. The pressing rotating body 42 extends substantially in the axial direction of the heating rotating body 41 and is rotated while being pressed against the heating rotating body 41 at a predetermined pressure. A contact portion in which the heating rotating body 41 and the pressing rotating body 42 of the fixing device 40 are in contact with each other serves as a fixing process section in which a predetermined fixing process (heating and pressing) is performed.

The sheet feeding device 50 is disposed below the yellow (Y), magenta (M), cyan (C), and black (K) image forming devices 10 (Y, M, C, and K) in the vertical direction Z. The sheet feeding device 50 includes one or more paper sheet containers 51 and feeding devices 52. Each paper sheet container 51 contains the recording paper sheets 5 of the desired size, type, etc., in a stacked manner. Each feeding device 52 feeds the recording paper sheets 5 one at a time from the corresponding paper sheet container 51. The paper sheet containers 51 are, for example, mounted to be capable of being pulled out of the apparatus body 1a at the front side (side the user faces during operation), that is, the near side in FIG. 1.

Examples of the recording paper sheets 5 include sheets of plain paper or thin paper and OHP sheets used in, for example, electrophotographic copy machines and printers. To increase the smoothness of the image surfaces after the fixing process, the surfaces of the recording paper sheets 5 may be made as smooth as possible. The recording paper sheets 5 may be, for example, so-called thick sheets having a relatively large basis weight, such as sheets of coated paper obtained by coating the surfaces of plain paper with an image receiving layer made of synthetic resin or the like, or sheets of art paper for printing.

One or more paper sheet transport roller pairs 53 and 54 and a sheet transport path 56 are provided between the sheet feeding device 50 and the second transfer device 30. The paper sheet transport roller pairs 53 and 54 transport each recording paper sheet 5 fed from the sheet feeding device 50 to the second transfer position. The sheet transport path 56 includes transport guides 55. The paper sheet transport roller pair 53 serves as, for example, a pair of registration rollers that adjusts the time when the recording paper sheet 5 is transported. Output rollers 58 are disposed above the fixing device 40 in the vertical direction Z. The output rollers 58 output the recording paper sheet 5 fed from the fixing device 40 after the fixing process to an output tray 57 such that the image surface faces upward. The output tray 57 is disposed outside the apparatus body 1a (on the left side of the apparatus body 1a in FIG. 1).

The image forming apparatus 1 includes a post-processing device 100 disposed above the apparatus body 1a and below the image reading device 2. The post-processing device 100 performs post-processing on the recording paper sheet 5 having the image formed thereon by the image forming apparatus 1. The post-processing device 100 includes a second fixing device 60 and a sheet cutting device 70. A switching gate 59 and transport rollers 58a are disposed at the upper end of the apparatus body 1a. The switching gate 59 switches the transport path of the recording paper sheet 5 between the path for outputting the recording paper sheet 5 to the output tray 57 and the path toward the post-processing device 100 that performs the post-processing. The transport rollers 58a transport the recording paper sheet 5 to the post-processing device 100 when the transport path is switched by the switching gate 59.

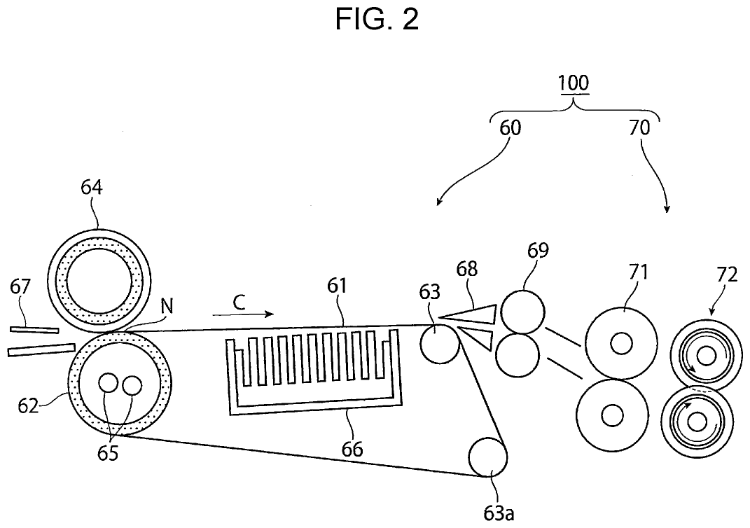

As illustrated in FIG. 2, the second fixing device 60 includes an endless fixing belt 61, a heating roller 62, a separation roller 63, a walk control roller 63a, a pressing roller 64, halogen lamps 65, a heat sink 66, a guide member 67, a separation guide 68, and a transport roller pair 69. The heating roller 62 heats the fixing belt 61. The pressing roller 64 is pressed against the heating roller 62 with the fixing belt 61 disposed therebetween to form a nip portion N. The halogen lamps 65 are disposed in a hollow section of the heating roller 62 and heat a predetermined region of the nip portion N. The heat sink 66 cools the recording paper sheet 5 that is in close contact with the fixing belt 61. The guide member 67 guides the recording paper sheet 5 to the nip portion N. The separation guide 68 assists and guides the separation of the recording paper sheet 5 from the fixing belt 61. The transport roller pair 69 transports the separated recording paper sheet 5 to the sheet cutting device 70. The heating roller 62 is rotationally driven by a drive source (not illustrated). The fixing belt 61 is rotationally driven in the direction of arrow C in FIG. 2 at a predetermined speed.

The heat sink 66 for performing forced cooling by coming into contact with the fixing belt 61 is provided on the inner surface of the fixing belt 61 at a location between the heating roller 62 and the separation roller 63. An urging roller (not illustrated) is disposed to face the heat sink 66 with the fixing belt 61 disposed therebetween. The urging roller urges the recording paper sheet 5 against the fixing belt 61 to assist close contact between the transported recording paper sheet 5 and the fixing belt 61. A tension roller (not illustrated) having a small diameter that applies constant tension to the fixing belt 61 is provided between the heat sink 66 for cooling and the heating roller 62.

The second fixing device 60 operates as follows. After the toner image is fixed to the surface of the recording paper sheet 5 by the fixing device 40 of the image forming apparatus 1, the recording paper sheet 5 is guided by the guide member 67, as illustrated in FIG. 2, and enters the nip portion N with the image surface facing the fixing belt 61. In the nip portion N, the toner forming the toner image on the recording paper sheet 5 is melted by the heat applied by the heating roller 62 heated with the halogen lamps 65 and pressure applied by the pressing roller 64. Thus, the toner image is embedded in an image-receiving layer of the recording paper sheet 5 that is softened with heat.

Then, the recording paper sheet 5 is transported while remaining in close contact with the fixing belt 61 after passing through the nip portion N. The recording paper sheet 5 is subjected to forced cooling by the heat sink 66 while being transported, and the smooth surface of the fixing belt 61 is transferred to the image-receiving layer. As a result, the glossiness of the recording paper sheet 5 and the toner image is increased. After that, the recording paper sheet 5 is cooled to a temperature lower than or equal to the melting temperature of the color toners in a region around the separation roller 63, and then is separated from the fixing belt 61 by the toughness (rigidity) of the recording paper sheet 5 at the separation roller 63.

Referring to FIG. 1, toner cartridges 144 (Y, M, C, and K) filled with developers containing at least the toners to be supplied to the corresponding developing devices 14 (Y, M, C, and K) are arranged to extend in the direction perpendicular to the plane of FIG. 1.

Referring to FIG. 1, a control device 200 performs centralized control of the operation of the image forming apparatus 1 including the post-processing device 100. The control device 200 includes a central processing unit (CPU), a read only memory (ROM), a random access memory (RAM), a bus that connects the CPU, ROM, etc., a communication interface, and an operation panel. All of these components are not illustrated.

### Operation of Image Forming Apparatus

A basic image forming operation performed by the image forming apparatus 1 will now be described.

An operation for forming a full-color image by combining toner images of four colors (Y, M, C, and K) using the four image forming devices 10 (Y, M, C, and K) will be described.

Referring to FIG. 1, when the control device 200 of the image forming apparatus 1 receives command information of a request for an image forming operation (print operation), the four image forming devices 10 (Y, M, C, and K), the intermediate transfer device 20, the second transfer device 30, and the fixing device 40 are activated.

In each of the image forming devices 10 (Y, M, C, and K), the photoconductor drum 11 rotates in the direction of arrow A. Next, the charging device 12 charges the surface of the photoconductor drum 11 to a predetermined potential of a predetermined polarity (negative in the first exemplary embodiment). Subsequently, the exposure device 13 irradiates the charged surface of the photoconductor drum 11 with light emitted on the basis of an image signal obtained by converting the image information input to the image forming apparatus 1 into components of the respective colors (Y, M, C, and K). Thus, an electrostatic latent image of the corresponding color having a predetermined potential difference is formed on the surface of the photoconductor drum 11.

Subsequently, the developing devices 14 (Y, M, C, and K) develop the electrostatic latent images of the respective colors formed on the photoconductor drums 11 by supplying toners of the respective colors (Y, M, C, and K), which are charged to a predetermined polarity (negative polarity), from the developing rollers 141 and causing the toners to electrostatically adhere to the photoconductor drums 11. Thus, the electrostatic latent images of the respective colors formed on the photoconductor drums 11 are developed with the toners of the respective colors and made visible as toner images of the four colors (Y, M, C, and K).

Subsequently, the toner images of the respective colors formed on the photoconductor drums 11 of the image forming devices 10 (Y, M, C, and K) reach the first transfer positions. The first transfer devices 15 (Y, M, C, and K) perform the first transfer process in which the toner images of the respective colors are successively transferred onto the intermediate transfer belt 21, which is included in the intermediate transfer device 20 and rotates in the direction of arrow B, in a superposed manner.

After the first transfer process, the drum cleaning device 16 of each of the image forming devices 10 (Y, M, C, and K) cleans the surface of the corresponding photoconductor drum 11 by scraping off deposits therefrom. Thus, the image forming devices 10 (Y, M, C, and K) are made ready for the next image forming operation.

Subsequently, the intermediate transfer belt 21 of the intermediate transfer device 20 rotates to carry and transport the toner images that have been transferred thereto in the first transfer process to the second transfer position. The sheet feeding device 50 feeds the recording paper sheet 5 to the sheet transport path 56 in accordance with the image forming operation. The paper sheet transport roller pair 53, which serves as a pair of registration rollers, feeds the recording paper sheet 5 toward the second transfer position along the sheet transport path 56 at the time corresponding to the transfer time.

The toner images on the intermediate transfer belt 21 are simultaneously transferred onto the recording paper sheet 5 in the second transfer process by the second transfer roller 31 of the second transfer device 30 at the second transfer position. After the second transfer process, the belt cleaning device 27 of the intermediate transfer device 20 cleans the surface of the intermediate transfer belt 21 by removing residual toner and other deposits therefrom.

Subsequently, the recording paper sheet 5 to which the toner images have been transferred in the second transfer process is removed from the intermediate transfer belt 21 and the second transfer roller 31 and transported to the fixing device 40. The fixing device 40 causes the recording paper sheet 5 after the second transfer process to pass through the contact section between the heating rotating body 41 and the pressing rotating body 42 that rotate. The unfixed toner images on the recording paper sheet 5 are fixed to the recording paper sheet 5 by a necessary fixing process (heating and pressing). Lastly, after the fixing process, the recording paper sheet 5 is output to the output tray 57 disposed outside the apparatus body 1a by the output rollers 58 when post-processing by the post-processing device 100 is not performed.

When the recording paper sheet 5 is to be subjected to post-processing, the switching gate 59 transports the recording paper sheet 5 on which the image is formed to the post-processing device 100 through the transport rollers 58a. In the post-processing device 100, the second fixing device 60 performs the above-described process of increasing the glossiness, and the sheet cutting device 70, which is an example of a sheet cutting unit, performs a process of cutting the recording paper sheet 5 as described below.

As a result of the above-described operation, the recording paper sheet 5 having a full-color image, which is formed by combining the toner images of the four colors, formed thereon is output.

### Structure of Sheet Cutting Device

As described above, the image forming apparatus 1 includes the post-processing device 100 above the apparatus body 1a, as illustrated in FIG. 1. The post-processing device 100 is attached to the top of the apparatus body 1a of the image forming apparatus 1 as an optional device, or is mounted in an upper end section of the apparatus body 1a of the image forming apparatus 1 in advance.

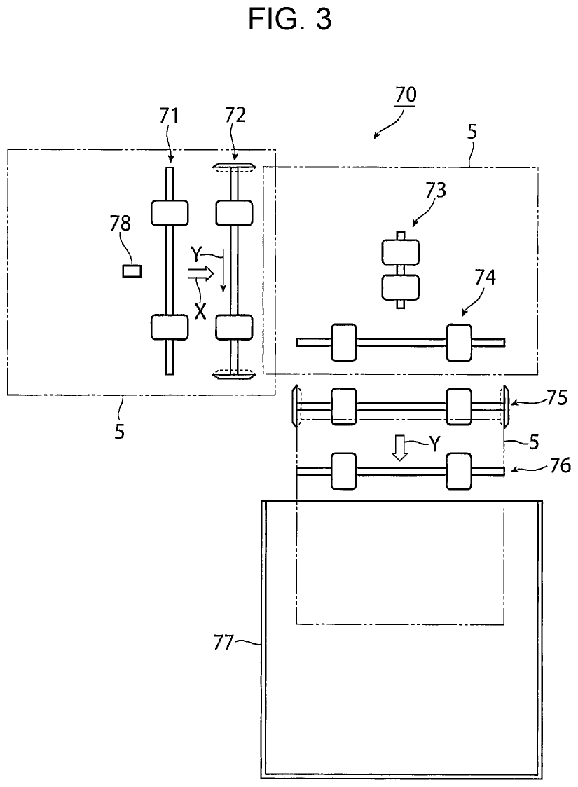

As illustrated in FIG. 3, the sheet cutting device 70 basically includes a first transport roller pair 71, a first cutter mechanism 72 that serves as an example of a first cutting unit, a second transport roller pair 73, a third transport roller pair 74, a second cutter mechanism 75 that serves as an example of a second cutting unit, and an output roller pair 76.

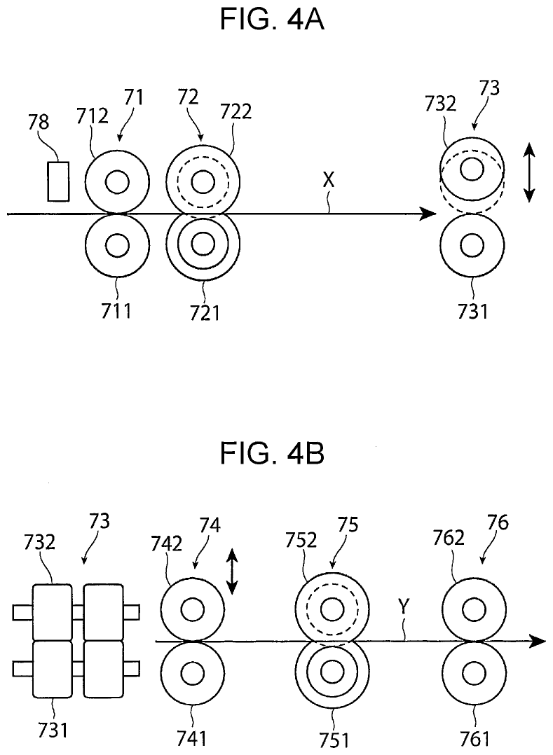

The first transport roller pair 71 transports the recording paper sheet 5 subjected to the process of increasing the glossiness performed by the second fixing device 60 in the X direction, which is an example of a first transport direction. As illustrated in FIG. 4A, the first transport roller pair 71 is composed of a pair of transport rollers 711 and 712 that nip the recording paper sheet 5 in the vertical direction Z and transport the recording paper sheet 5.

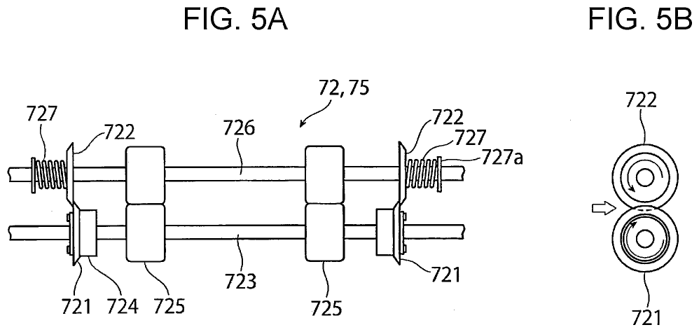

The first cutter mechanism 72 cuts both end portions of the recording paper sheet 5 in the Y direction crossing the X direction, which is the first transport direction in which the recording paper sheet 5 is transported by the first transport roller pair 71. As illustrated in FIG. 5A, the first cutter mechanism 72 includes two pairs of first and second rotating blades 721 and 722 that mesh with each other in the vertical direction Z at inner and outer positions in the axial direction to cut the recording paper sheet 5. The first and second rotating blades 721 and 722 are formed as single-edged blades including blade bodies having a circular shape in front view, as illustrated in FIG. 5B, and including outer peripheral portions with surfaces opposite to the meshing surfaces being sharpened toward the edge (peripheral edge).

Each pair of the first and second rotating blades 721 and 722 constitutes a pair of cutting blades that rotate in mesh with each other to cut the recording paper sheet 5. The first cutter mechanism 72 includes the pair of first and second rotating blades 721 and 722 constituting the pair of cutting blades at each end in the axial direction. As a result, the first cutter mechanism 72 constitutes a cutter mechanism in which the pairs of cutting blades composed of the first and second rotating blades 721 and 722 are provided at both ends in the axial direction.

However, the first cutter mechanism 72 may include only one pair of cutting blades composed of the first and second rotating blades 721 and 722 when, for example, only one end portion of the recording paper sheet 5 in the direction crossing the transport direction is cut.

The first cutter mechanism 72 is capable of simultaneously cutting both end portions of the recording paper sheet 5 in the Y direction crossing the transport direction by transporting the recording paper sheet 5 in the X direction, which is the first transport direction. The recording paper sheet 5 cut by the first cutter mechanism 72 is transported with reference to the center in the direction Y crossing the transport direction X. After the recording paper sheet 5 is cut, the width of the recording paper sheet 5 is equal to the interval between the two pairs of cutting blades.

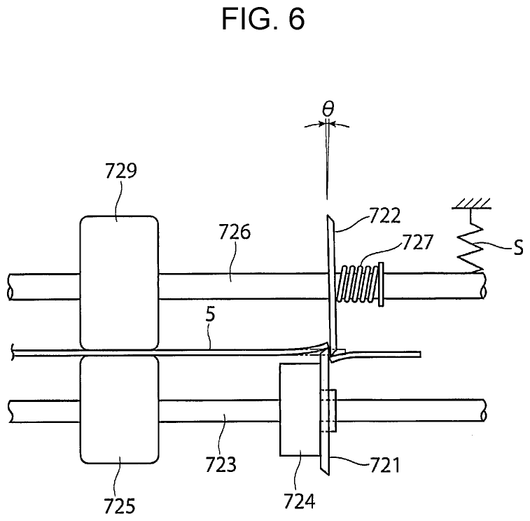

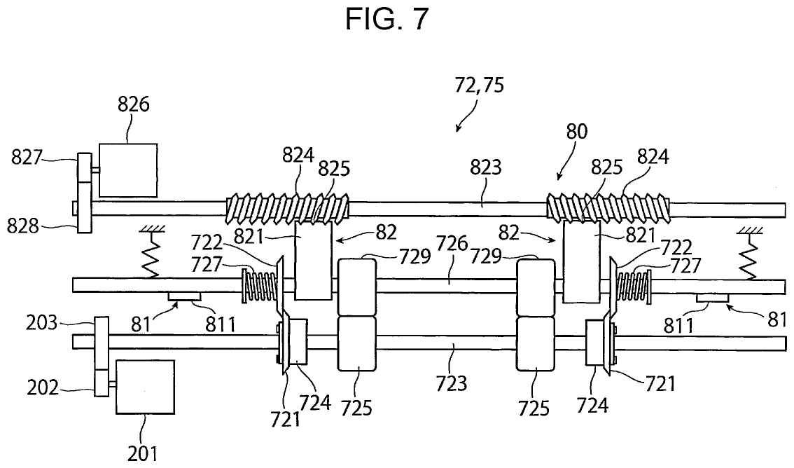

As illustrated in FIGS. 5A and 6, each first rotating blade 721 is fixed to a first rotating shaft 723 with a fixing member 724. The first rotating blade 721, which is disposed at a lower position in the vertical direction Z, constitutes an inner blade positioned at an inner position in the axial direction. The fixing member 724 is not necessarily disposed on the inner side of the first rotating blade 721 in the axial direction of the first rotating shaft 723, and may be disposed on the outer side of the first rotating shaft 723. As illustrated in FIG. 7, the first rotating shaft 723 is rotationally driven at a predetermined speed by a drive motor 201, which is an example of a drive source, through reduction gears 202 and 203.

Driving rollers 725 are fixed to the first rotating shaft 723 of the first rotating blades 721. Each driving roller 725 is one of transport rollers constituting a transport roller pair that nips and transports the recording paper sheet 5. The driving rollers 725 are disposed on the inner side of the first rotating blades 721 in the axial direction of the first rotating shaft 723 with a predetermined interval therebetween.

The second rotating blades 722 are disposed outside the first rotating blades 721 in the axial direction, and are attached to a second rotating shaft 726 such that the second rotating blades 722 are movable in the axial direction of the second rotating shaft 726. Each second rotating blade 722, which is disposed at an upper position in the vertical direction Z, constitutes an outer blade. Each second rotating blade 722 is disposed in contact with the corresponding first rotating blade 721 without leaving a gap therebetween and is maintained inclined relative to the first rotating blade 721 at a predetermined small angle θ so that the recording paper sheet 5 can be cut.

Furthermore, as illustrated in FIG. 6, each second rotating blade 722 is urged inward relative to the second rotating shaft 726 in the axial direction by a coil spring 727, which is an example of an urging unit, so that the second rotating blade 722 is in contact with the first rotating blade 721. One end (outer end) 727a of the coil spring 727 is fixed to the second rotating shaft 726. The second rotating blade 722 has an inner surface in contact with a projecting member (not illustrated), for example, so that the second rotating blade 722 rotates while being maintained inclined relative to the first rotating blade 721 by the predetermined small angle θ such that the lower end thereof is slightly farther away from the first rotating blade 721 than the upper end thereof.

Pinch rollers 729 are provided on the second rotating shaft 726 of the second rotating blades 722. Each pinch roller 729 is the other one of the transport rollers constituting the transport roller pair that nips and transports the recording paper sheet 5. The pinch rollers 729 are disposed on the inner side of the second rotating blades 722 in the axial direction of the second rotating shaft 726 with a predetermined interval therebetween such that the pinch rollers 729 face the driving rollers 725. The second rotating shaft 726 is urged by coil springs S, which are examples of urging units, through bearing members (not illustrated) or the like so that the pinch rollers 729 are in contact with the driving rollers 725. The second rotating shaft 726 is rotated when the pinch rollers 729 are in contact with the driving rollers 725. The second rotating shaft 726 extends through long holes in a frame (not illustrated) of the sheet cutting device 70 and is supported such that the second rotating shaft 726 is rotatable and movable in the vertical direction Z.

As illustrated in FIG. 3, the second transport roller pair 73 transports the recording paper sheet 5 in the X direction, which is the first transport direction, while preventing rising of the leading end portion of the recording paper sheet 5 after both edges of the recording paper sheet 5 in the Y direction are cut by the first cutter mechanism 72. As illustrated in FIGS. 4A and 4B, the second transport roller pair 73 includes a pair of transport rollers 731 and 732 that nip the recording paper sheet 5 in the vertical direction Z and transport the recording paper sheet 5 in a central region in the Y direction crossing the transport direction X of the recording paper sheet 5. Of the pair of transport rollers 731 and 732, the transport roller 732 disposed at an upper position in the vertical direction is retractable upward at a predetermined timing so that the transport roller 732 does not impede the movement of the recording paper sheet 5 when the third transport roller pair 74 transports the recording paper sheet 5 in the Y direction.

The third transport roller pair 74 transports the recording paper sheet 5 in the Y direction, which is a second transport direction crossing the first transport direction, after both edges of the recording paper sheet 5 in the Y direction are cut by the first cutter mechanism 72. As illustrated in FIG. 4B, the third transport roller pair 74 includes a pair of transport rollers 741 and 742 that nip the recording paper sheet 5 in the vertical direction Z and transport the recording paper sheet 5. The transport roller 742 of the third transport roller pair 74 is retractable upward so that the third transport roller pair 74 does not impede the transport of the recording paper sheet 5 when the first cutter mechanism 72 cuts both end portions of the recording paper sheet 5 in the Y direction.

The third transport roller pair 74 nips the recording paper sheet 5 and transports the recording paper sheet 5 in the Y direction, which is the second transport direction, after the first cutter mechanism 72 completes cutting both edges of the recording paper sheet 5 in the Y direction.

As illustrated in FIG. 3, the second cutter mechanism 75 cuts both end portions of the recording paper sheet 5 in the X direction crossing the Y direction, which is the second transport direction in which the recording paper sheet 5 is transported by the third transport roller pair 74.

The structure of the second cutter mechanism 75 is similar to that of the first cutter mechanism 72. Here, elements of the second cutter mechanism 75 are denoted by the same reference numerals as those of the first cutter mechanism 72 in FIGS. 5A, 5B, and 6 and other figures, and description thereof is thus omitted. Similarly to the first cutter mechanism 72, the second cutter mechanism 75 includes first and second rotating blades 721 and 722.

As illustrated in FIG. 3, the output roller pair 76 outputs the recording paper sheet 5 to an output tray 77 after both edges of the recording paper sheet 5 are cut by the second cutter mechanism 75 so that recording paper sheet 5 has a predetermined length and width. The output tray 77 is disposed at a position accessible by the user from the front side of the image forming apparatus 1. As illustrated in FIG. 4B, the output roller pair 76 includes a pair of transport rollers 761 and 762 that nip the recording paper sheet 5 in the vertical direction Z and transport the recording paper sheet 5.

As illustrated in FIGS. 3 and 4A, a paper sheet sensor 78 that detects the leading end of the recording paper sheet 5 is disposed upstream of the first transport roller pair 71 in the transport direction of the recording paper sheet 5.

The control device 200 controls the timing for driving the first to third transport roller pairs 71, 73, and 74 and the first and second cutter mechanisms 72 and 75 and the upward retraction based on a detection signal obtained by the paper sheet sensor 78.

The sheet cutting device 70 having the above-described structure is normally capable of cutting the recording paper sheet 5 with a thickness and a hardness within predetermined ranges based on, for example, the basis weight and the material. However, there is a possibility that the sheet cutting device 70 will receive the recording paper sheet 5 with a thickness or hardness outside the predetermined allowable range. When the sheet cutting device 70 receives the recording paper sheet 5 with a thickness or hardness outside the allowable range, the first and second rotating blades 721 and 722 cannot perform the cutting process.

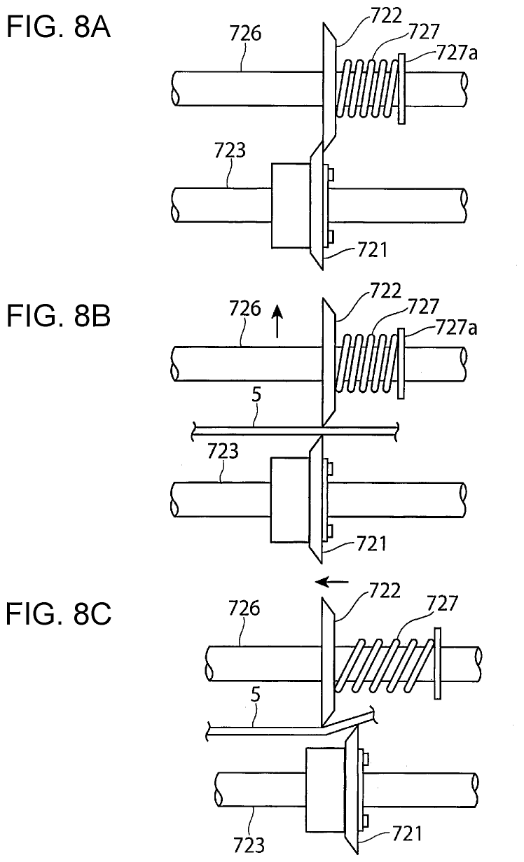

As illustrated in FIGS. 8A to 8C, when the sheet cutting device 70 receives the recording paper sheet 5 with a thickness or hardness outside the allowable range, the first and second rotating blades 721 and 722 cannot perform the cutting process. Therefore, the second rotating shaft 726 moves upward against the urging force of the coil springs S, and each second rotating blade 722 also moves upward and onto the recording paper sheet 5. Then, in the sheet cutting device 70, since the second rotating blade 722 that serves as a driven blade is urged inward in the axial direction by the coil spring 727, the second rotating blade 722 moves inward in the axial direction beyond the first rotating blade 721, and the first and second rotating blades 721 and 722 are unmeshed.

When the first and second rotating blades 721 and 722 are unmeshed, the sheet cutting device 70 can no longer perform the operation of cutting the recording paper sheet 5. Therefore, the recording paper sheet 5 that is not cut into the predetermined size is output to the output tray 77, and the user recognizes that the sheet cutting device 70 is out of order.

When the sheet cutting device 70 is out of order, the user calls a customer engineer (CE). The customer engineer (CE) manually re-meshes and restores the first and second rotating blades 721 and 722. Therefore, the sheet cutting device 70 according to the related art cannot be used until the first and second rotating blades 721 and 722 are re-meshed and restored, and has a technical problem in that down time is incurred. The sheet cutting device 70 according to the related also has a technical problem in that the task of re-meshing and restoring the first and second rotating blades 721 and 722 needs to be performed carefully and requires skill because the first and second rotating blades 721 and 722 are sharp and handled manually by the customer engineer (CE).

The above-described technical problems are not limited to the case in which the recording paper sheet 5 with a thickness or hardness outside the allowable range is supplied. Even when the thickness and hardness of the recording paper sheet 5 are within the allowable ranges, the first and second rotating blades 721 and 722 may become blunt due to wear, for example, after long use of the sheet cutting device 70. Also in this case, the above-described technical problems occur due to meshing failure of the first and second rotating blades 721 and 722.

Accordingly, to enable the unmeshed first and second rotating blades to return to the original state without the need for manual intervention by, for example, the customer engineer, the sheet cutting device according to the first exemplary embodiment includes a restoring unit. When the positional relationship between the inner and outer positions of the first and second rotating blades in the axial direction is reversed, the restoring unit releases the first and second rotating blades from each other and moves at least one of the first and second rotating blades in the axial direction to restore the positional relationship between the inner and outer positions to the original state.

In the sheet cutting device according to the first exemplary embodiment, the restoring unit includes a releasing unit that releases the first and second rotating blades from each other and a moving unit that moves one of the first and second rotating blades in the axial direction.

According to the sheet cutting device 70 of the first exemplary embodiment, when the first and second rotating blades 721 and 722 are unmeshed as illustrated in FIG. 8C, the recording paper sheet 5 cannot be cut and is therefore output from the output tray 77 without being cut to the predetermined size, causing the user to recognize the situation.

The sheet cutting device 70 may include a size detection unit (not illustrated) that detects the size of the recording paper sheet 5 that has passed the first cutter mechanism 72 and the second cutter mechanism 75. In this case, the size detection unit may detect the presence of an uncut portion left at one or both ends of the recording paper sheet 5 in the direction crossing the transport direction. This enables automatic detection of meshing failure of the first and second rotating blades 721 and 722 in the first cutter mechanism 72 and/or the second cutter mechanism 75.

As illustrated in FIG. 7, the sheet cutting device 70 according to the first exemplary embodiment includes a restoring mechanism 80 as an example of the restoring unit. When the positional relationship between the inner and outer positions of each pair of the first and second rotating blades 721 and 722 in the axial direction is reversed, the restoring mechanism 80 releases the first and second rotating blades 721 and 722 from each other and moves the second rotating blade 722 as at least one of the first and second rotating blades 721 and 722 in the axial direction to restore the positional relationship between the inner and outer positions to the original state. The restoring mechanism 80 is provided for each of the first and second cutter mechanisms 72 and 75. The first cutter mechanism 72 will be described herein as an example.

The restoring mechanism 80 includes a retracting mechanism 81 as an example of the releasing unit and a moving mechanism 82 as an example of the moving unit. The retracting mechanism 81 releases the first and second rotating blades 721 and 722 from each other. The moving mechanism 82 moves the second rotating blade 722 as at least one of the first and second rotating blades 721 and 722 in the axial direction.

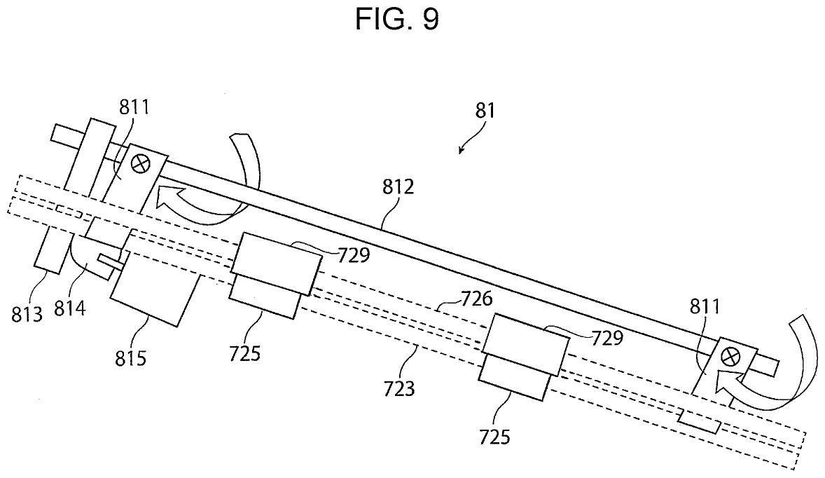

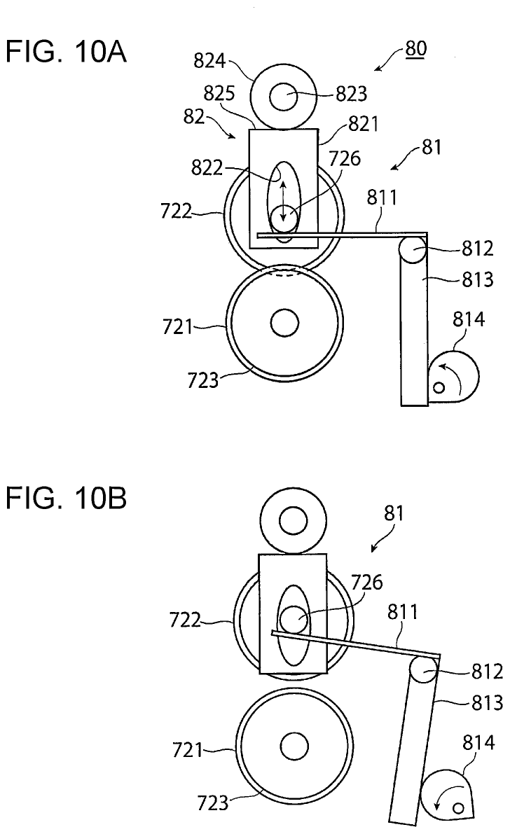

As illustrated in FIGS. 9, 10A, and 10B, the retracting mechanism 81 includes arm members 811 as examples of swingable operating arms that move the second rotating shaft 726 of the first cutter mechanism 72 upward. The arm members 811 are attached to both end portions of a driving shaft 812 in the axial direction so as to project in a direction crossing the driving shaft 812 in a cantilever manner. A lever member 813 that rotates the driving shaft 812 is provided on one end portion of the driving shaft 812 in the axial direction so as to project in a direction crossing the driving shaft 812 in a cantilever manner. The driving shaft 812 is rotatably attached to a frame (not illustrated) of the sheet cutting device 70.

As illustrated in FIGS. 10A and 10B, an eccentric cam 814 is maintained in contact with an end portion (lower end portion) of the lever member 813 by an urging force applied by an urging unit, such as a spring (not illustrated), engaged with the driving shaft 812. The eccentric cam 814 is stopped after being rotationally driven by a drive motor 815 to rotate in a predetermined direction by a predetermined amount.

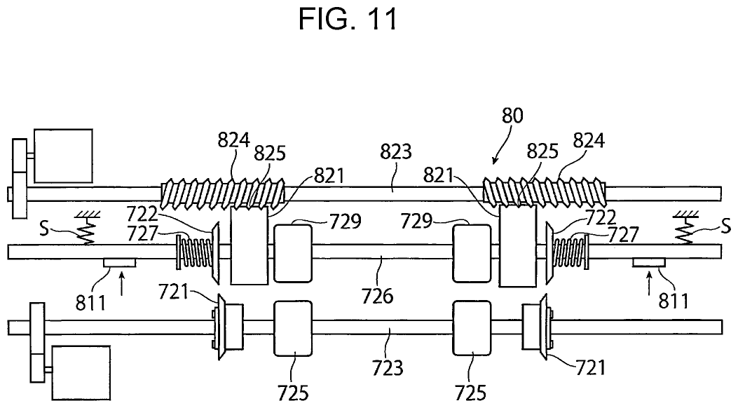

In the retracting mechanism 81, the eccentric cam 814 is rotationally driven by the drive motor 815 to rotate in a predetermined direction by a predetermined amount, so that the lever member 813 attached to the driving shaft 812 is rotationally driven. Accordingly, the driving shaft 812 having the lever member 813 attached to one end portion thereof rotates together with the lever member 813. When the driving shaft 812 rotates clockwise, the arm members 811 fixed to the driving shaft 812 move upward so that, as illustrated in FIG. 11, the second rotating shaft 726 of the first cutter mechanism 72 moves upward to release the first rotating blades 721 and the second rotating blades 722 from one another.

As illustrated in FIGS. 7, 10A, and 10B, the moving mechanism 82 includes moving members 821 that move the second rotating blades 722 in the axial direction of the second rotating shaft 726. The moving members 821 have long holes 822 through which the second rotating shaft 726 is inserted such that the second rotating shaft 726 is movable in the up-down direction. The moving members 821 are maintained in the illustrated state by a guide member (not illustrated) even when the second rotating shaft 726 is moved in the up-down direction. Rack gears 825 and 825 that constantly mesh with worm gears 824 and 824 attached to a drive shaft 823 are provided at the upper ends of the moving members 821. The worm gears 824 and 824 are attached to one end portion and the other end portion of the drive shaft 823 in the axial direction such that the directions thereof are opposite to each other. When the drive shaft 823 is rotationally driven in one direction, one of the worm gears 824 and 824 provided on one end portion (left end portion in FIG. 7) of the drive shaft 823 moves the corresponding one of the rack gears 825 and 825 toward one end (left end in FIG. 7) in the axial direction, and the worm gear 824 provided on the other end portion (right end portion in FIG. 7) of the drive shaft 823 moves the corresponding one of the rack gear 825 and 825 toward the other end (right end in FIG. 7) in the axial direction. As illustrated in FIG. 7, the drive shaft 823 is rotationally driven by a drive motor 826 disposed at one end thereof in the axial direction through reduction gears 827 and 828.

The moving members 821 are capable of being reciprocated in the axial direction of the drive shaft 823 by the rack gears 825 and 825 that mesh with the worm gears 824 and 824 attached to the drive shaft 823 when the drive shaft 823 is rotationally driven by the drive motor 826.

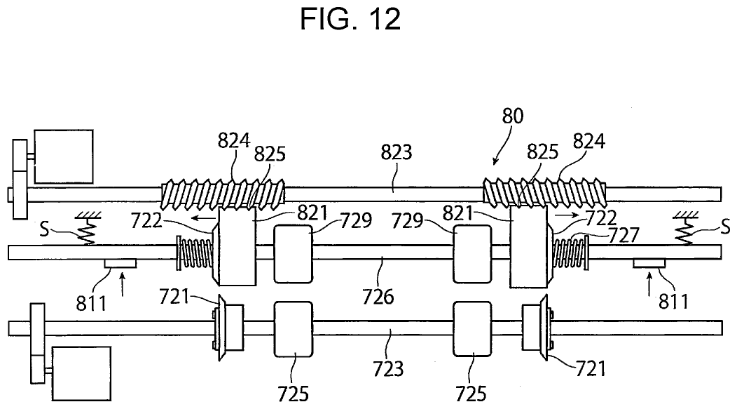

As illustrated in FIG. 12, when the moving members 821 move in the axial direction of the drive shaft 823, the moving members 821 come into contact with the second rotating blades 722 provided on the second rotating shaft 726 and move the second rotating blades 722 in the axial direction against the urging force applied by the coil springs 727.

### Operation of Sheet Cutting Device

The sheet cutting device 70 according to the first exemplary embodiment is capable of restoring the unmeshed first and second rotating blades 721 and 722 to the original state, as described below, without the need for manual intervention by, for example, a customer engineer.

More specifically, in the sheet cutting device 70 according to the first exemplary embodiment, as illustrated in FIGS. 8A to 8C, when the recording paper sheet 5 with a thickness or hardness outside the allowable range is supplied or when the first and second rotating blades 721 and 722 become blunt due to wear, for example, the second rotating blade 722 urged by the coil spring 727 may move inward beyond the first rotating blade 721, and the first and second rotating blades 721 and 722 may be unmeshed.

In such a case, as illustrated in FIG. 8C, the sheet cutting device 70 cannot perform the operation of cutting the recording paper sheet 5. Therefore, the recording paper sheet 5 that is not cut to the predetermined size is output to the output tray 77, and the user recognizes that the sheet cutting device 70 is out of order.

When the user recognizes that the sheet cutting device 70 is out of order, the user operates a restore button, for example, provided on an operation panel (not illustrated) of the image forming apparatus 1 to execute a restore operation for the sheet cutting device 70.

When the restore button provided on the operation panel is operated, the control device 200 of the image forming apparatus 1 performs the restore operation described below.

The control device 200 of the image forming apparatus 1 may be configured to automatically detect that the sheet cutting device 70 is out of order and display a message stating, for example, “Sheet cutting device is out of order. Operate restore button on operation panel.” on the operation panel (not illustrated) to prompt the user to operate the restore button.

When the restore button is operated, as illustrated in FIG. 9, the control device 200 rotationally drives the drive motor 815 of the retracting mechanism 81 to rotate the eccentric cam 814 so that the driving shaft 812 is rotated clockwise by the lever member 813.

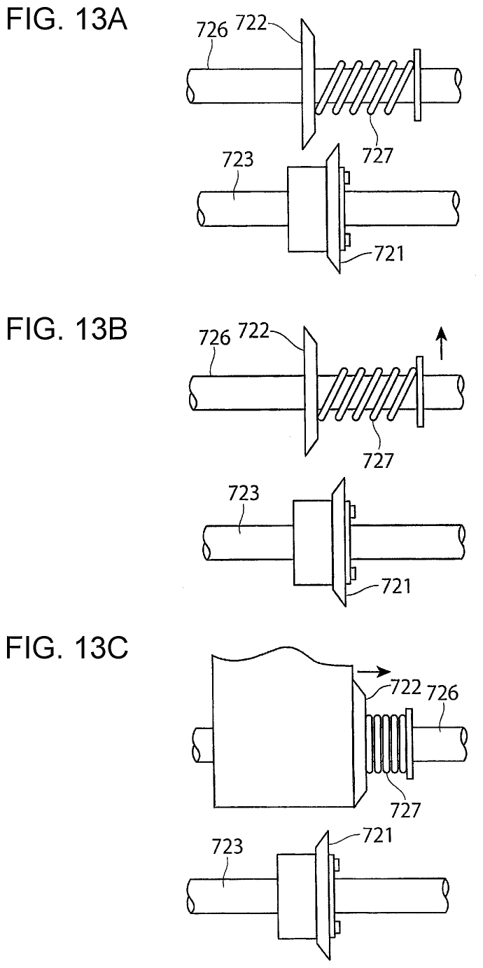

Accordingly, as illustrated in FIG. 10B, the arm members 811 provided on the driving shaft 812 rotate to move the second rotating shaft 726 upward. Thus, as illustrated in FIGS. 13A and 13B, the arm members 811 release the second rotating blades 722 provided on the second rotating shaft 726 from the first rotating blades 721.

Next, as illustrated in FIG. 11, the control device 200 rotationally drives the drive motor 826 of the moving mechanism 82 to rotate the worm gears 824 and 824 attached to the drive shaft 823. Thus, the moving members 821 having the rack gears 825 and 825 meshing with the worm gears 824 and 824 move in the axial direction of the second rotating shaft 726.

When each second rotating blade 722 reaches a position outside the corresponding first rotating blade 721 in the axial direction of the second rotating shaft 726 as illustrated in FIG. 13C, the drive motor 826 of the moving mechanism 82 is stopped to stop the second rotating blade 722 at this position.

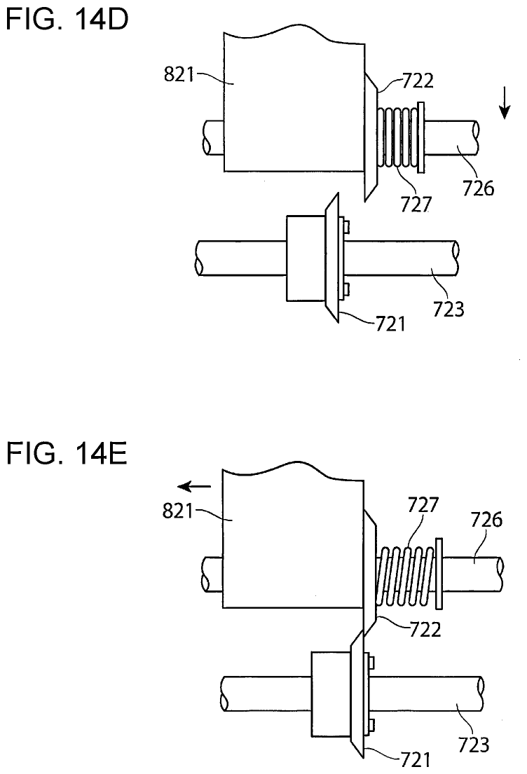

After that, as illustrated in FIG. 10A, the control device 200 rotationally drives the drive motor 815 of the retracting mechanism 81 to rotate the eccentric cam 814 so that the driving shaft 812 is rotated counterclockwise by the lever member 813. Accordingly, the arm members 811 provided on the driving shaft 812 rotate to move the second rotating shaft 726 downward, as illustrated in FIG. 14D, so that each second rotating blade 722 provided on the second rotating shaft 726 is moved to a position at which the second rotating blade 722 can mesh with the corresponding first rotating blade 721.

Lastly, as illustrated in FIG. 12, the control device 200 rotationally drives the drive motor 826 of the moving mechanism 82 to rotate the worm gears 824 and 824 attached to the drive shaft 823. Thus, the moving members 821 having the rack gears 825 and 825 meshing with the worm gears 824 and 824 move in the axial direction of the second rotating shaft 726.

As a result, as illustrated in FIG. 14E, each second rotating blade 722 is restored to the state in which the second rotating blade 722 is in contact with the corresponding first rotating blade 721 by the urging force applied by the coil spring 727. After that, the moving members 821 move to standby positions that are spaced from the second rotating blades 722 by predetermined distances in the axial direction, and the restore operation is completed.

When the completion of the restore operation is detected, the control device 200 displays information that the sheet cutting device 70 is usable on the operation panel of the image forming apparatus 1.

### Second Exemplary Embodiment

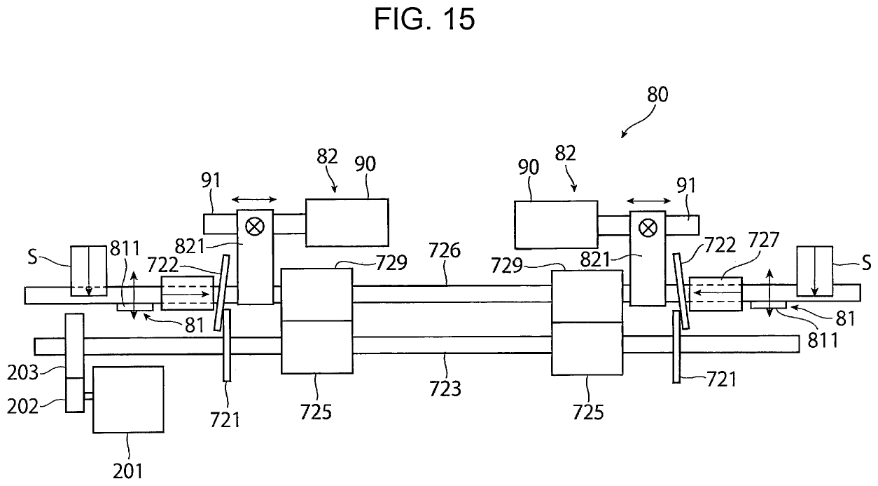

FIG. 15 illustrates the structure of a sheet cutting device according to a second exemplary embodiment. The sheet cutting device according to the second exemplary embodiment differs from that of the first exemplary embodiment in the structure of the moving mechanism.

More specifically, in the sheet cutting device 70 according to the second exemplary embodiment, as illustrated in FIG. 15, the moving mechanism is not composed of the combinations of the worm gears 824 and 824 and the rack gears 825 and 825, but is composed of solenoids 90 for moving the second rotating blades 722 in the axial direction.

Similarly to the first exemplary embodiment, the second rotating shaft 726 of the second rotating blades 722 is provided with the moving members 821 for moving the second rotating blades 722 in the axial direction. The upper ends of the moving members 821 are fixed to movable iron cores 91 of the solenoids 90. The amounts by which the movable iron cores 91 project may be changed in one or more steps by changing the currents or voltages applied to the solenoids 90.

The moving members 821 and the solenoids 90 are arranged to correspond to the second rotating blades 722 disposed at both end portions of the second rotating shaft 726 in the axial direction.

In the sheet cutting device 70 according to the second exemplary embodiment, the second rotating blade 722 is movable in the axial direction simply by placing the solenoids 90. Therefore, the size of the restoring mechanism 80 may be reduced.

The moving mechanism is not limited to those driven by the solenoids 90 and may include, for example, sliders driven by motors or the like and movable in the axial direction of the second rotating shaft 726.

Other structures and operations are similar to those of the first exemplary embodiment, and description thereof is thus omitted.

### Third Exemplary Embodiment

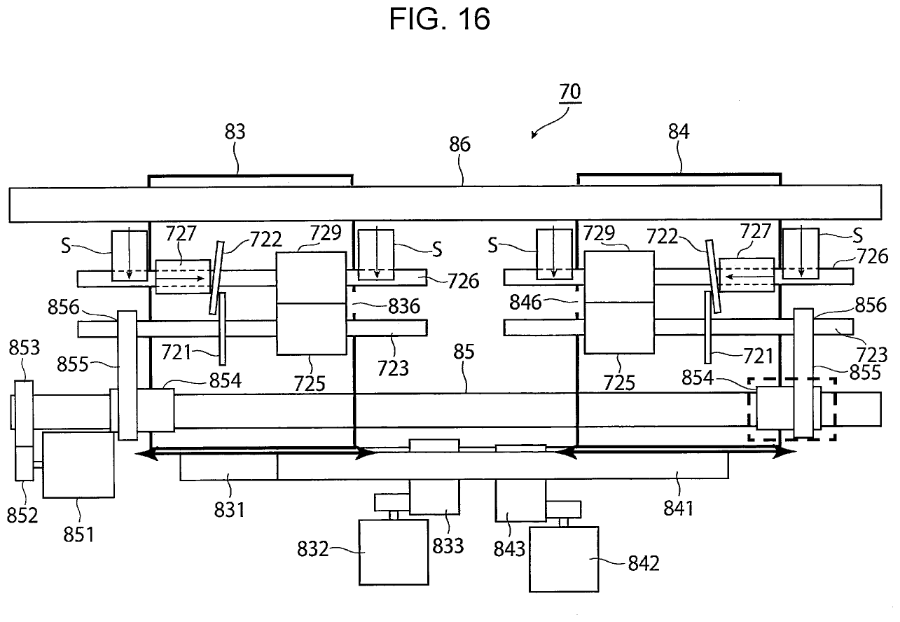

FIG. 16 illustrates the structure of a sheet cutting device according to a third exemplary embodiment. According to the sheet cutting device 70 of the third exemplary embodiment, the cutting width of the sheet in the direction crossing the transport direction of the sheet is changeable.

As illustrated in FIG. 16, in the sheet cutting device 70 according to the third exemplary embodiment, the first rotating blades 721 provided at both ends in the axial direction are not attached to the same first rotating shaft 723 but are attached to left and right first rotating shafts 723 divided from each other in the axial direction. The second rotating blades 722 provided at both ends in the axial direction are not attached to the same second rotating shaft 726 but are attached to left and right second rotating shafts 726 divided from each other in the axial direction. In this sheet cutting device 70, the first cutter mechanism 72 and the second cutter mechanism 75 have the same structure.

The sheet cutting device 70 includes left and right brackets 83 and 84 disposed at both ends in the axial direction. Each of the left and right brackets 83 and 84 is a substantially rectangular-parallelepiped-shaped box having left and right side walls, which support the first and second rotating shafts 723 and 726 in a rotatable manner, and top and bottom walls. The left and right brackets 83 and 84 are attached to two guide shafts 85 and 86 such that the left and right brackets 83 and 84 are movable toward and away from each other. The guide shafts 85 and 86 extend parallel to each other in a horizontal direction at upper and lower positions. The left and right brackets 83 and 84 are attached to the two guide shafts 85 and 86 to maintain the positional accuracy of the first and second rotating blades 721 and 722 disposed in the left and right brackets 83 and 84. The lower guide shaft 85 also serves as a drive shaft that rotationally drives the first and second rotating blades 721 and 722 disposed in the left and right brackets 83 and 84. The lower guide shaft 85 is rotationally driven by a drive motor 851 disposed at one end of the lower guide shaft 85 in the axial direction through reduction gears 852 and 853.

The left and right brackets 83 and 84 support the left and right first rotating shafts 723 divided from each other in the axial direction and the left and right second rotating shafts 726 divided from each other in the axial direction in a rotatable manner. The first rotating shafts 723 supported by the left and right brackets 83 and 84 are rotationally driven at the same rotational speed by the lower guide shaft 85 through driving pulleys 854, driving belts 855, and driven pulleys 856. The driving pulleys 854 are attached to the lower guide shaft 85 such that the driving pulleys 854 are movable in the axial direction.

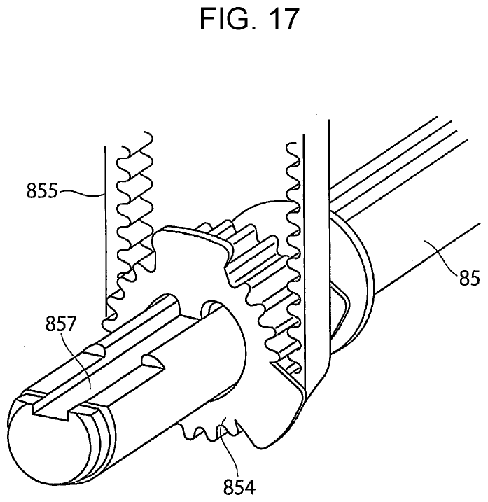

As illustrated in FIG. 17, each driving pulley 854 is attached to the lower guide shaft 85 such that the driving pulley 854 is movable in the axial direction along a guide groove 857 and capable of transmitting the rotational driving force. Each driven pulley 856 is movable in the axial direction in response to the movement of the driving pulley 854 and capable of transmitting the rotational driving force.

Similarly to the first exemplary embodiment, each second rotating shaft 726 on which the second rotating blade 722 is provided has the pinch roller 729 brought into contact with the driving roller 725 by the urging force applied by the coil springs S provided at both ends of the second rotating shaft 726, and is thereby rotated.

The left and right brackets 83 and 84 are movable by symmetrical distances in the horizontal direction by long rack gears 831 and 841 provided at the lower ends of the left and right brackets 83 and 84 and pinion gears 833 and 843 rotationally driven by drive motors 832 and 842.

Referring to FIG. 16, in the sheet cutting device 70 according to the third exemplary embodiment, the drive motors 832 and 842 may be rotationally driven to move the left and right brackets 83 and 84 through the pinion gears 833 and 843 and the rack gears 831 and 841. Thus, the interval between the two pairs of first and second rotating blades 721 and 722 may be changed, and the cutting width of the recording paper sheet 5 may be changed accordingly.

In the image forming apparatus 1 including the sheet cutting device 70, the cutting dimension of the recording paper sheet 5 in each of the longitudinal and transverse directions may be input through, for example, the operation panel. Accordingly, the left and right brackets 83 and 84 may be moved so that the distance therebetween is equal to the input dimension, and the recording paper sheet 5 may be cut to desired widths in the longitudinal and transverse directions.

The opposing walls of the left and right brackets 83 and 84 have openings 836 and 846 for allowing the recording paper sheet 5 to pass therethrough.

Other structures and operations are similar to those of the first exemplary embodiment, and description thereof is thus omitted.

### Fourth Exemplary Embodiment

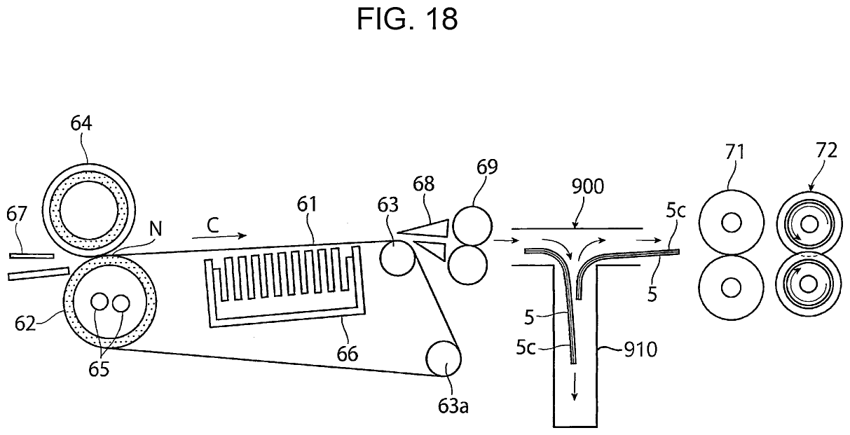

FIG. 18 illustrates the structure of a sheet cutting device according to a fourth exemplary embodiment. The sheet cutting device 70 according to the fourth exemplary embodiment is configured to reduce damage to the image formed on the recording paper sheet when the recording paper sheet is cut.

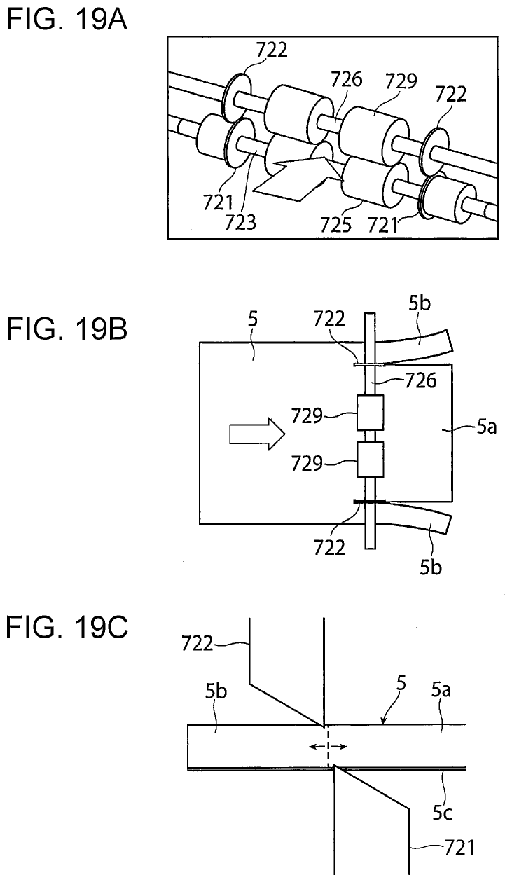

As illustrated in FIGS. 19A to 19C, the sheet cutting device 70 is structured such that when the recording paper sheet 5 is cut, the first and second rotating blades 721 and 722 that rotate come into contact with the front and back surfaces of the recording paper sheet 5, and both end portions of the recording paper sheet 5 in the direction crossing the transport direction are cut off. At this time, the recording paper sheet 5 is divided into a resultant sheet 5a from which both end portions in the direction crossing the transport direction are cut off, and cut-off portions 5b that are positioned on both sides of the resultant sheet 5a and that are to be discarded.

It has been confirmed by stress analysis that, when the sheet cutting device 70 cuts the recording paper sheet 5 with the first and second rotating blades 721 and 722 as illustrated in FIG. 19C, high stress is applied to a portion of the recording paper sheet 5 with which the first and second rotating blades 721 and 722 are in contact. Therefore, when the first or second rotating blade 721 or 722 comes into contact with an image surface 5c of the resultant sheet 5a of the recording paper sheet 5, the image surface 5c of the recording paper sheet 5 may be damaged by the first or second rotating blade 721 or 722 (first rotating blade 721 in the illustrated example), and marks may be formed on the image. Thus, the image quality may be reduced.

Instead of using rotating blades with sharp edges for both the first and second rotating blades 721 and 722, a flat plate-shaped rotating blade having a blunt edge may be used as one of the first and second rotating blades 721 and 722 to reduce the costs without affecting the performance of cutting the recording paper sheet 5. When the flat plate-shaped rotating blade is positioned to face the image surface 5c of the recording paper sheet 5, the image surface 5c of the recording paper sheet 5 is significantly damaged.

Accordingly, the sheet cutting device 70 of the fourth exemplary embodiment is structured such that, when the recording paper sheet 5 is cut by the first and second rotating blades 721 and 722, the first or second rotating blade 721 or 722 does not come into contact with the image surface 5c of the resultant sheet 5a of the recording paper sheet 5, and the first or second rotating blade 721 or 722 (second rotating blade 722 in the illustrated example) comes into contact with the image surface 5c of each cut-off portion 5b of the recording paper sheet 5.

As illustrated in FIG. 18, the sheet cutting device 70 according to the fourth exemplary embodiment includes a reversing mechanism 900 disposed downstream of the second fixing device 60 in the transport direction of the recording paper sheet 5. The reversing mechanism 900 reverses the recording paper sheet 5 that has passed through the second fixing device 60.

The reversing mechanism 900 does not directly transport the recording paper sheet 5 that has passed through the second fixing device 60 to the sheet cutting device 70, but temporarily transports the recording paper sheet 5 to a reversing path 910 provided with reversing rollers (not illustrated). Then, the reversing mechanism 900 reverses the transport direction of the recording paper sheet 5 transported to the reversing path 910 to reverse the front and back sides of the recording paper sheet 5.

After the transport direction of the recording paper sheet 5 is reversed at the reversing path 910, the recording paper sheet 5 is transported to the sheet cutting device 70 with the image surface 5c facing upward.

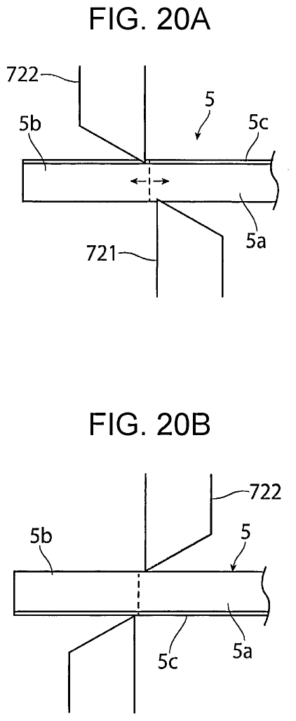

Referring to FIG. 20A, the sheet cutting device 70 performs the operation of cutting the recording paper sheet 5 by bringing the second rotating blade 722, which is an outer blade positioned at an outer position in the axial direction, into contact with the image surface 5c of the cut-off portion 5b of the recording paper sheet 5 and bringing the first rotating blade 721 into contact with a surface of the resultant sheet 5a of the recording paper sheet 5 opposite to the image surface 5c.

The sheet cutting device 70 performs a similar cutting operation at the second cutter mechanism 75.

Thus, in the sheet cutting device 70 according to the fourth exemplary embodiment, when the recording paper sheet 5 is cut by the first and second rotating blades 721 and 722, the image surface of the resultant sheet 5a of the recording paper sheet 5 may be reliably prevented from being damaged by the first or second rotating blade 721 or 722. Thus, the image quality of the recording paper sheet 5 may be increased.

In the image forming apparatus 1 including the sheet cutting device 70 according to the fourth exemplary embodiment, the post-processing device 100 includes the second fixing device 60 for increasing the glossiness of the recording paper sheet 5. Therefore, the recording paper sheet 5 is transported toward the sheet cutting device 70 with the image surface 5c facing downward.

Therefore, as illustrated in FIG. 20B, the sheet cutting device 70 may be structured such that the second rotating blade 722 serves as an inner blade that comes into contact with a surface (upper surface) of the resultant sheet 5a at a side opposite to the image surface 5c at the lower side of the recording paper sheet 5, and such that the first rotating blade 721 serves as an outer blade that comes into contact with the image surface of the resultant sheet 5a at the lower side of the recording paper sheet 5. In this case, the reversing mechanism 900 may be omitted.

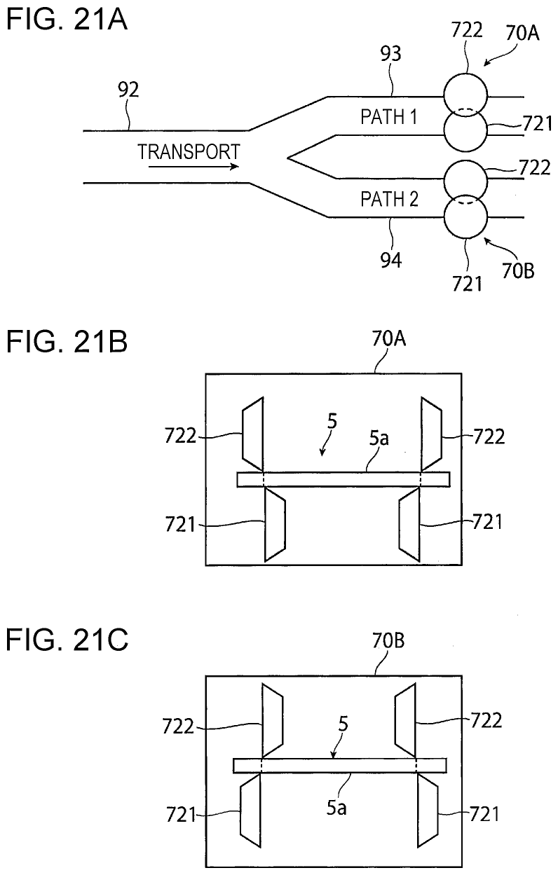

FIGS. 21A, 21B, and 21C illustrate the structure of a modification of the sheet cutting device 70 according to the fourth exemplary embodiment.

The sheet cutting device 70 illustrated in FIGS. 21A to 21C includes a transport path 92 along which the recording paper sheet 5 to be subjected to the cutting process is transported and that branches into two paths, which are a first transport path 93 and a second transport path 94, at an intermediate position. The first transport path 93, along which the recording paper sheet 5 having the image surface facing upward is transported, is provided with a first sheet cutting device 70A. As illustrated in FIG. 21B, the first sheet cutting device 70A includes first rotating blades 721 that come into contact with a surface (lower surface) of the resultant sheet 5a at a side opposite to the image surface at the upper side of the recording paper sheet 5, and second rotating blades 722 that come into contact with the image surface (upper surface) of the resultant sheet 5a at the upper side of the recording paper sheet 5.

The second transport path 94, along which the recording paper sheet 5 having the image surface facing downward is transported, is provided with a second sheet cutting device 70B. As illustrated in FIG. 21C, the second sheet cutting device 70B includes second rotating blades 722 that come into contact with a surface (upper surface) of the resultant sheet 5a at a side opposite to the image surface at the lower side of the recording paper sheet 5, and first rotating blades 721 that come into contact with the image surface (lower surface) of the cut-off portions 5b at the lower side of the recording paper sheet 5.

In this sheet cutting device 70, switching between the first and second transport paths 93 and 94 is performed depending on whether the image surface 5c is at the upper side of the recording paper sheet 5 or the lower side of the recording paper sheet 5.

According to the sheet cutting device 70 illustrated in FIGS. 21A to 21C, it is not necessary to reverse the front and back sides of the recording paper sheet 5. Therefore, the time required for the operation of cutting the recording paper sheet 5 may be reduced.

Although a full-color image forming apparatus is described in the exemplary embodiments, the image forming apparatus may, of course, be a monochrome image forming apparatus.

In the above-described exemplary embodiments, the sheet cutting device is mounted in the image forming apparatus as a post-processing device. However, the sheet cutting device may, of course, be provided as an independent post-processing device that is separate from the image forming apparatus.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

A sheet cutting device including:
first and second rotating blades that mesh with each other at inner and outer positions in an axial direction and that cut a sheet; and
a restoring unit,
wherein, when a positional relationship between the inner and outer positions of the first and second rotating blades in the axial direction is reversed, the restoring unit releases the first and second rotating blades from each other and moves at least one of the first and second rotating blades in the axial direction to restore the positional relationship between the inner and outer positions to an original state.
   (((2)))

The sheet cutting device according to (((1))),
wherein the restoring unit includes
   a releasing unit that releases the first and second rotating blades from each other, and
   a moving unit that moves one of the first and second rotating blades in the axial direction.
      (((3)))

The sheet cutting device according to (((2))),
wherein one of the first and second rotating blades is a fixed rotating blade that is fixed in the axial direction on a rotating shaft, and other of the first and second rotating blades is an urged rotating blade that is movably urged to be in contact with the fixed rotating blade, and
wherein the moving unit moves the urged rotating blade.

(((4)))

The sheet cutting device according to (((3))), wherein the moving unit includes a pushing member that pushes the urged rotating blade in the axial direction.

(((5)))

The sheet cutting device according to (((4))), wherein the pushing member includes a rack gear that meshes with a rotationally driven pinion gear.

(((6)))

The sheet cutting device according to (((2))),
wherein one of the first and second rotating blades is a rotationally driven rotating blade and other of the first and second rotating blades is a rotated rotating blade, and
wherein the releasing unit moves the rotated rotating blade in a direction crossing the axial direction to release the first and second rotating blades from each other.
   (((7)))

The sheet cutting device according to (((6))), wherein the releasing unit moves a rotating shaft of the rotated rotating blade in the direction crossing the axial direction.

(((8)))

The sheet cutting device according to (((7))), wherein the releasing unit includes an operating arm and a drive source that rotationally drives the operating arm, the operating arm being capable of swinging the rotating shaft of the rotated rotating blade in the direction crossing the axial direction.

(((9)))

The sheet cutting device according to (((1))), wherein the first and second rotating blades are provided at each of end portions spaced from each other in the axial direction by a predetermined interval.

(((10)))

The sheet cutting device according to (((9))), wherein rotating shafts of the first and second rotating blades are provided with respective transport members that come into contact with each other to transport the sheet.

(((11)))

An image forming apparatus including:
an image forming unit that forms an image on a sheet; and
a sheet cutting unit that cuts the sheet on which the image is formed by the image forming unit.
wherein the sheet cutting device according to one of (((1))) to (((10))) is used as the sheet cutting unit.

What is claimed is:

1. A sheet cutting device comprising:
first and second rotating blades that mesh with each other at inner and outer positions in an axial direction and that cut a sheet; and
a restoring unit,
wherein, when a positional relationship between the inner and outer positions of the first and second rotating blades in the axial direction is reversed, the restoring unit releases the first and second rotating blades from each other and moves at least one of the first and second rotating blades in the axial direction to restore the positional relationship between the inner and outer positions to an original state.

2. The sheet cutting device according to claim 1,
wherein the restoring unit includes
a releasing unit that releases the first and second rotating blades from each other, and
a moving unit that moves one of the first and second rotating blades in the axial direction.

3. The sheet cutting device according to claim 2, wherein one of the first and second rotating blades is a fixed rotating blade that is fixed in the axial direction on a rotating shaft, and other of the first and second rotating blades is an urged rotating blade that is movably urged to be in contact with the fixed rotating blade, and
wherein the moving unit moves the urged rotating blade.

4. The sheet cutting device according to claim 3, wherein the moving unit includes a pushing member that pushes the urged rotating blade in the axial direction.

5. The sheet cutting device according to claim 4, wherein the pushing member includes a rack gear that meshes with a rotationally driven pinion gear.

6. The sheet cutting device according to claim 2,
wherein one of the first and second rotating blades is a rotationally driven rotating blade and other of the first and second rotating blades is a rotated rotating blade, and
wherein the releasing unit moves the rotated rotating blade in a direction crossing the axial direction to release the first and second rotating blades from each other.

7. The sheet cutting device according to claim 6, wherein the releasing unit moves a rotating shaft of the rotated rotating blade in the direction crossing the axial direction.

8. The sheet cutting device according to claim 7, wherein the releasing unit includes an operating arm and a drive source that rotationally drives the operating arm, the operating arm being capable of swinging the rotating shaft of the rotated rotating blade in the direction crossing the axial direction.

9. The sheet cutting device according to claim 1, wherein the first and second rotating blades are provided at each of end portions spaced from each other in the axial direction by a predetermined interval.

10. The sheet cutting device according to claim 9, wherein rotating shafts of the first and second rotating blades are provided with respective transport members that come into contact with each other to transport the sheet.

11. An image forming apparatus comprising:
an image forming unit that forms an image on a sheet; and
a sheet cutting unit that cuts the sheet on which the image is formed by the image forming unit,
wherein the sheet cutting device according to claim 1 is used as the sheet cutting unit.

12. An image forming apparatus comprising:
an image forming unit that forms an image on a sheet; and
a sheet cutting unit that cuts the sheet on which the image is formed by the image forming unit,
wherein the sheet cutting device according to claim 2 is used as the sheet cutting unit.

13. An image forming apparatus comprising:
an image forming unit that forms an image on a sheet; and
a sheet cutting unit that cuts the sheet on which the image is formed by the image forming unit,
wherein the sheet cutting device according to claim 3 is used as the sheet cutting unit.

14. An image forming apparatus comprising:
an image forming unit that forms an image on a sheet; and
a sheet cutting unit that cuts the sheet on which the image is formed by the image forming unit,
wherein the sheet cutting device according to claim 4 is used as the sheet cutting unit.

15. An image forming apparatus comprising:
an image forming unit that forms an image on a sheet; and
a sheet cutting unit that cuts the sheet on which the image is formed by the image forming unit,
wherein the sheet cutting device according to claim 5 is used as the sheet cutting unit.

16. An image forming apparatus comprising:
an image forming unit that forms an image on a sheet; and
a sheet cutting unit that cuts the sheet on which the image is formed by the image forming unit,
wherein the sheet cutting device according to claim 6 is used as the sheet cutting unit.

17. An image forming apparatus comprising:
an image forming unit that forms an image on a sheet; and
a sheet cutting unit that cuts the sheet on which the image is formed by the image forming unit,
wherein the sheet cutting device according to claim 7 is used as the sheet cutting unit.

18. An image forming apparatus comprising:
an image forming unit that forms an image on a sheet; and
a sheet cutting unit that cuts the sheet on which the image is formed by the image forming unit,
wherein the sheet cutting device according to claim 8 is used as the sheet cutting unit.

19. An image forming apparatus comprising:
an image forming unit that forms an image on a sheet; and
a sheet cutting unit that cuts the sheet on which the image is formed by the image forming unit,
wherein the sheet cutting device according to claim 9 is used as the sheet cutting unit.

20. An image forming apparatus comprising:
an image forming unit that forms an image on a sheet; and
a sheet cutting unit that cuts the sheet on which the image is formed by the image forming unit,
wherein the sheet cutting device according to claim 10 is used as the sheet cutting unit.
